(19) United States
(12) Patent Application Publication
(10) Pub. No.: US 2020/0394890 A1
(43) Pub. Date: Dec. 17, 2020

(54) ARRANGEMENT COMPRISING A CONTAINER FOR RECEIVING A COSMETIC PRODUCT AND A LID FOR CLOSING THE CONTAINER AND METHOD OF OPERATING SUCH AN ARRANGEMENT

(71) Applicant: SEIDEL GMBH & CO. KG, Marburg (DE)

(72) Inventors: Andreas RITZENHOFF, Marburg (DE); Oliver ARNOLD, Dautphetal (DE); Christian BISCHOFF, Wettenberg (DE)

(73) Assignee: SEIDEL GMBH & CO. KG, Marburg (DE)

(21) Appl. No.: 16/956,086

(22) PCT Filed: Dec. 19, 2018
(86) PCT No.: PCT/EP2018/085848

§ 371 Date: Jun. 19, 2020

(30) Foreign Application Priority Data
Dec. 22, 2017 (DE) 10 2017 131 231.5

(51) Int. Cl. G08B 21/18; A45D 40/06; A45D 34/00; A45D 40/00; H04W 4/80; G07C 1/10

(52) U.S. Cl. CPC G08B 21/18; A45D 40/06; G07C 1/10; A45D 40/0068; H04W 4/80; A45D 34/00

(57) ABSTRACT

An arrangement includes a container for receiving a cosmetic product and a lid for closing the container. The arrangement includes a circuit arrangement with a radio module that is arranged on or in the container and/or the lid, and which is adapted to detect an opening status of the arrangement and to output it via the radio module.

### BACKGROUND AND SUMMARY OF THE INVENTION

Exemplary embodiments of the invention relate to an arrangement of a container for holding a cosmetic product and a lid for closing the container, as well as to an operating procedure for such an arrangement.

Containers for cosmetic products or care products in general, which can be closed with a lid, are used in the form of jars or cans for cremes or other pasty products. Furthermore, containers in the form of bottles or flasks for perfume are used or in the form of oblong containers for lipsticks or mascara.

The containers usually have a capacity of a few milliliters (ml) to about 100 ml. Cosmetic products presented in these containers are usually sold in the container itself, with the sealable lid allowing safe transport. As additional protection, and as proof of intactness, the container may be sealed with a protective foil under the lid by the manufacturer. When used, the lid serves to safely re-seal the container in order to prevent contamination of the contents, e.g., by house dust, and to enable safe storage and transport, e.g., when travelling. The lid also protects the cosmetic product from drying out.

With many of the cosmetic products offered in such containers, the lasting success of these cosmetic products depends on regular use, if possible not interrupted by long breaks.

Exemplary embodiments of the present invention are directed to improving the above mentioned arrangement of a container for cosmetic products and a lid in such a way that regular application of the cosmetic product is made easier for the user. Exemplary embodiments are also directed to an operating procedure for such an arrangement for cosmetic products which assists the user in regular use.

An arrangement consisting of a container and a lid in accordance with the invention includes a circuit arrangement with a radio module arranged on or in the container and/or the lid, which is set up to detect an opening status of the arrangement and to output it via the radio module.

An arrangement in accordance with the invention is thus designed to automatically detect when the container is open or closed (i.e., whether the lid closes the container or not). Knowledge of the opening status of the container allows conclusions to be drawn about the use of the cosmetic product. It is also possible to detect whether the container is open for a longer period of time, which could accelerate the drying out of the cosmetic product. The integrated radio module allows the information about the opening status of the container to be passed on and recorded and evaluated by external devices.

In an advantageous embodiment of the arrangement, the radio module is designed to output the opening status according to a standardized protocol for short-range radio transmission. The 2.4 gigahertz (GHz) band is particularly suitable as a frequency band due to its approval and distribution. Usable protocols are for example Bluetooth, Bluetooth-LE (low energy), ZigBee or similar.

In another advantageous embodiment, a sensor, e.g., a switch, is integrated in the container and/or lid, which detects the opening status and whose status is evaluated by the circuitry. Such a switch can be a microswitch and/or also a magnetic switch, e.g., a reed switch. If a reed switch is used, the switch itself can be located in the container or lid and a magnet actuating the switch can be located in the other component, i.e. the lid or container.

Preferably a screw cap is used as the lid, which allows the container to be closed securely. The screw cap is also preferably fitted with a circumferential sealing plate or a sealing plate extending over the entire inner surface of the cap. This sealing plate can also preferably be coupled to the switch in such a way that pressure on the sealing plate, which is exerted when the container is closed with the (screw) cap, is used to actuate the switch. For this purpose, the lid can, for example, be mounted so as to be displaceable in an axial direction (relative to the screw connection between lid and container), whereby the sealing plate is pretensioned in the direction of the container by at least one spring. When the lid is screwed onto the container, the sealing plate is moved against the spring force relative to the remaining part of the lid, thereby actuating the switch.

An operating method according to the invention for such an arrangement comprising a container for containing a cosmetic product and a lid for closing the container comprises the following steps: An opening status of the arrangement is detected, the opening status indicating whether the container is closed by the lid. The detected opening status is then output by a radio module of the assembly. This results in the advantages mentioned in connection with the arrangement.

In an advantageous embodiment of the operating procedure, the opening status is output with a radio protocol for short-range radio transmission, in particular Bluetooth, Bluetooth-LE or ZigBee. It may be planned to output the opening status repeatedly, e.g., at regular intervals. In order to save energy during radio transmission, it may also be planned to output the opening status only when the arrangement is open.

In an alternative operating mode, it may be intended to output the opening status if it is detected that it has changed. This represents a very energy-saving transmission. The output of the opening status after a change can also be output several times in quick succession to ensure that the information is received correctly.

### BRIEF DESCRIPTION OF THE DRAWING FIGURES

The invention is explained in more detail below by means of an embodiment using figures. The figures show:

FIG. 1 an isometric representation of a container with unscrewed lid;

FIG. 2 sectional view of the container and the lid according to FIG. 1;

FIG. 3a, b each an isometric exploded view of the container and of the lid as shown in FIGS. 1 and 2 from different directions of view;

FIG. 4 an isometric representation of the container with the lid screwed on;

FIG. 5 a sectional view of the container and the lid in the screwed together condition as shown in FIG. 4; and

FIG. 6 an alternative design of a lid in a sectional view.

### DETAILED DESCRIPTION

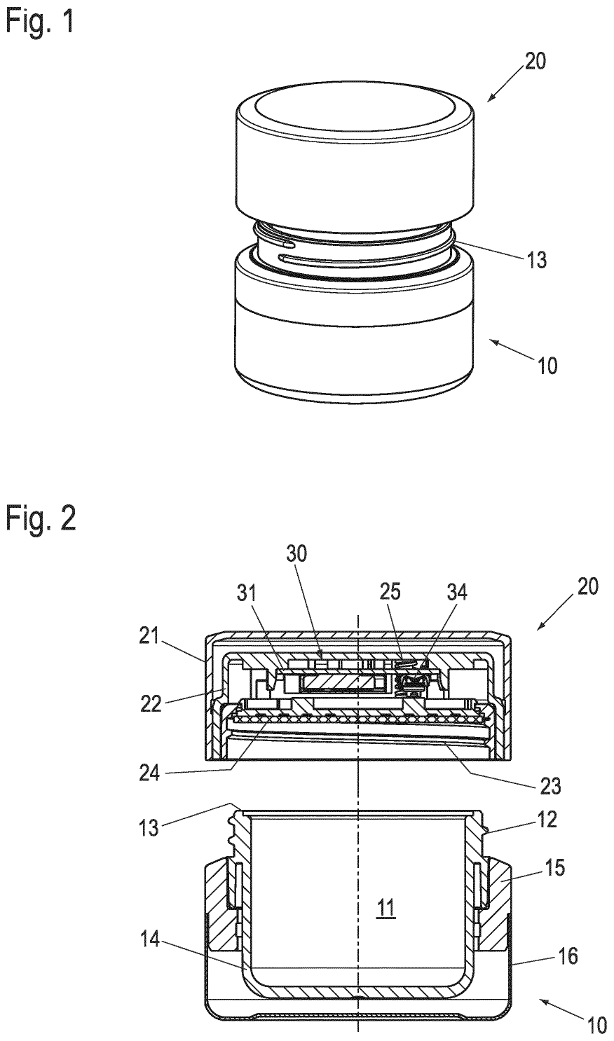

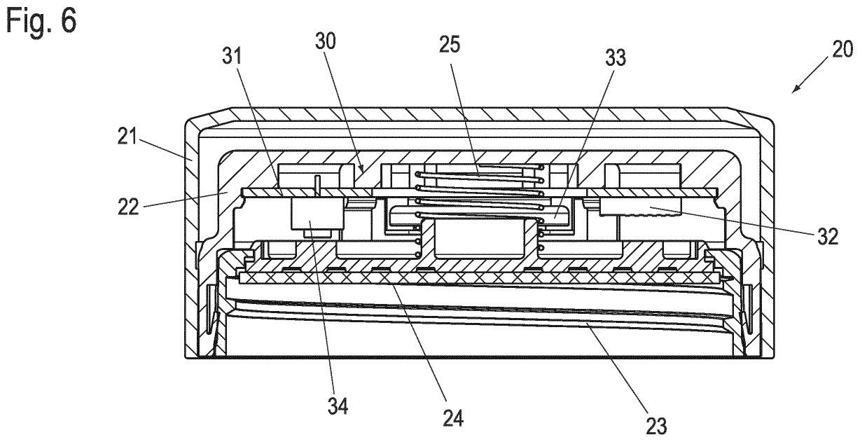

In the FIGS. 1 to 5 described below, an example of a container 10 with a lid 20 according to the invention is shown in various representations. FIG. 6 shows an alternative design of lid 20. In all figures, the same reference signs indicate identical or similarly acting elements. For reasons of clarity, not all elements in all figures are marked with all reference signs. The information used in the description, such as left, right, top, bottom, refers to the exemplary representation in the figures.

FIG. 1 first shows an embodiment of a container 10 for cosmetic products with a lid 20 unscrewed but still above the container 10. In this embodiment, container 10 and lid 20 are cylindrical. However, the basic idea described in this application is independent of the exact shape and dimensions of both container 10 and lid 20 and can be implemented in particular for containers and lids with other basic geometric shapes and/or proportions.

The shape of the container 10 shown in the examples is typical for a pasty cosmetic product, e.g., a creme. A container in accordance with the application can also be suitable for cosmetic products such as lipsticks or mascara in other dimensions or proportions. Furthermore, the container may also be designed to hold liquid cosmetic products and may take the form of a bottle or flask.

The container 10 has an external thread 12 on which the lid 20 is screwed with an internal thread (not visible in FIG. 1). The use of a screw connection is advantageous in terms of reclosability and tightness, but is not mandatory. There may also be other connection mechanisms such as a frictional connection, a bayonet lock and/or a snap-in lock between the container and the lid.

FIG. 2 shows the container 10 with the lid 20 according to FIG. 1 in a sectional view, the section being made along the central axis of the container 10 or the lid 20.

The sectional view shows that the container 10 has a cavity 11, which is used to hold the cosmetic product. With typical dimensions of the container 10 in terms of its diameter and height in the range of centimeters, the volume of cavity 11 can range from a few milliliters to several 10 ml or about 100 ml in typical applications. At the top, the container 10 ends in a circumferential and level upper edge 13 which seals it against the lid 20.

The container 10 is preferably constructed in several parts and has an inner part, which provides the cavity 11 and on the outside of which the thread 12 is formed at the top. This part is the actual sealed vessel 14 of container 10. Below the thread 12, this vessel 14 is inserted into a circumferential grip edge 15 and locked to it. The container 14 and the grip edge 15 can be made of plastic in an injection molding process. A glass container 14 can also be used. An outer sleeve 16 is connected to the grip edge 15, which surrounds the lower part of the container 14 and forms the lower part of the container 10. The grip edge 15 can be made of plastic, but can also be made of optical reasons or, to achieve a higher quality rating, of a metal, for example deep-drawn aluminum. The multi-part construction of the container 10 makes it possible, when using the same vessel 14, to give the container 10 a different appearance by using differently designed grip edges 15 and/or outer casings 16.

Lid 20 is also of multi-part design and has an outer hood 21, which can be made of deep-drawn aluminum or plastic. An insert 22 is inserted into this hood, which is preferably made of plastic and which carries all other components arranged in the lid 20.

A threaded insert 23 is inserted into the insert 22 and connected to the insert 22, e.g., snapped or glued. The threaded insert 23 provides the internal thread already mentioned, with which the lid 20 is screwed onto the thread 12 of the container 10.

A sealing plate 24 is inserted into the threaded insert 23. This can be a preferably thin plastic plate on which a sealing soft material is mounted. When screwing the lid 20 onto the container 10, the sealing plate 24 is pressed onto the upper edge 13 of the container 10 and thus seals the cavity 11 of the container 10.

The sealing plate 24 is pressed into a circumferential groove of the threaded insert 23, in which it has a small clearance of movement in axial direction, i.e., in the direction in which the lid 20 moves in relation to the container 10 when screwed on. Above the sealing plate 24 and supported internally by the insert 22, two springs 25 are arranged in the example shown, which pre-tension the sealing plate 24 in the direction of the container 10. Furthermore, a circuit arrangement 30 is arranged in a cavity between the sealing plate 24 and an upper inner surface of the insert 22, the function of which is explained in more detail in connection with the drawings described below.

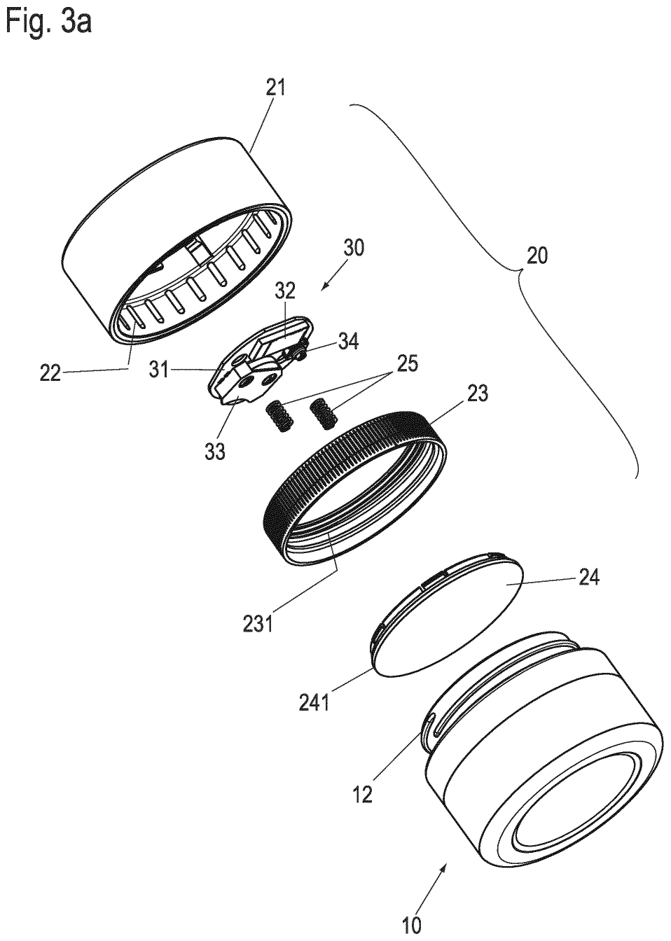

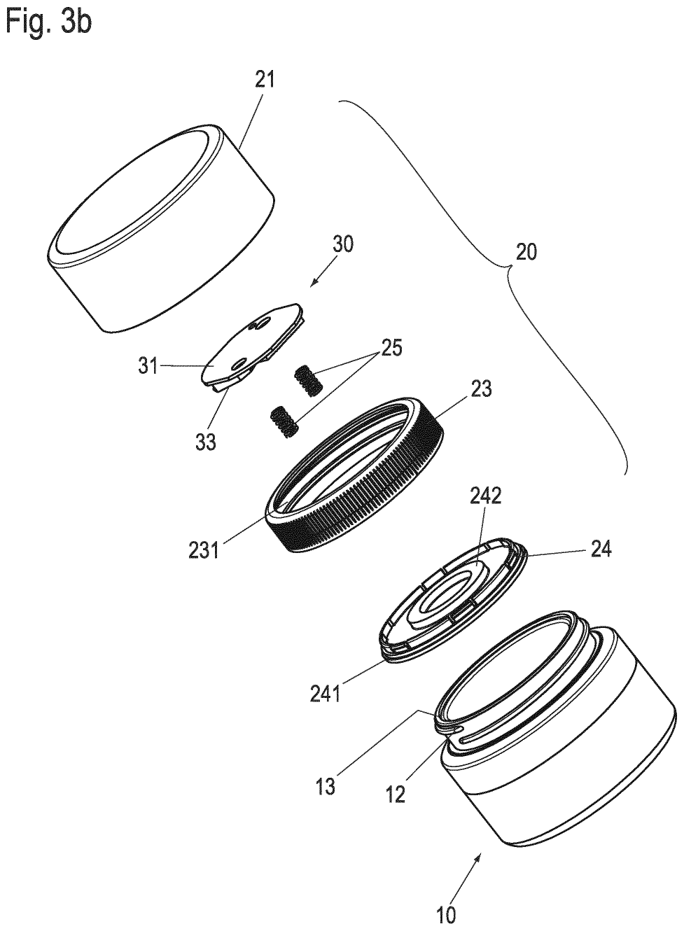

In FIGS. 3a and 3b, the structure of the lid 20 is shown in more detail in an iso-metric exploded view. In these drawings it can be seen in particular that a circumferential groove 231 is formed in the threaded insert 23, in which the sealing plate 24 engages with its outer edge 241. However, the groove has a height in the axial direction that is greater than the thickness of the edge 241, which gives the described vertical movement range of the sealing plate 24. On the upper side of the sealing plate 24 (see FIG. 3b) a circumferential support ring 242 is formed on which the springs 25 press. This ensures that there is a suitable support surface for the springs 25, even if the sealing plate 24 is twisted in relation to the insert 22, which usually occurs when the lid 20 is opened or closed and the sealing plate 24 rests on the upper edge 13 of the container 10.

FIGS. 3a and 3b also show the layout of circuit arrangement 30, which has a circuit board 31 on which all other components are arranged. These components are, in particular, a radio module 32, a battery holder 33 with a button cell battery and a switch 34. The switch 34 is an example of a sensor with which the opening status of the arrangement can be detected.

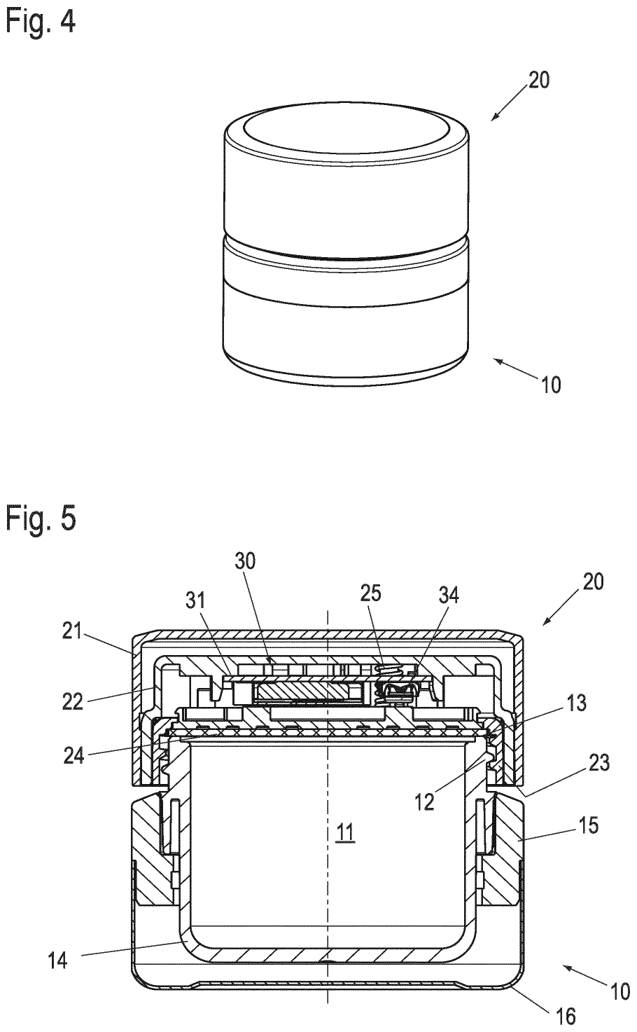

FIGS. 4 and 5 show the container 10 with the lid 20 screwed on in the same way as FIGS. 1 and 2. In this position the sealing plate 24 rests on the upper edge 13 of the container 10 and is pressed upwards within its clearance in the threaded insert 23 relative to the threaded insert 23. In this position, the sealing plate 24 with the support ring 242 presses on an actuating element of the switch 34, which in the example shown is a push-button microswitch. When the container 10 is opened by unscrewing the lid 20 (status shown in FIGS. 1, 2), the sealing plate 24 is pressed down relative to the threaded insert 23 by the springs 25 and, correspondingly, the switch 34 is no longer actuated. In this way the opening status of container 10 can be detected via switch 34.

The switch 34 is connected to the radio module 32 in such a way that the radio module 32 outputs the switching state of the switch 34 coded in a radio signal. It can be provided, for example, that a corresponding radio signal “Lid was opened” or “Lid was closed” is output each time the switching state of switch 34 changes. This radio signal may include a unique identification number of the circuit arrangement 30 in order to identify and thereby assign it.

It should be noted that it is not necessarily (only) the current opening status that can be output, but also past opening statuses that are stored in circuit arrangement 30. In this way it can be achieved, for example, that the opening and/or closing of container 10 in a period of time in which there was no coupling with the mobile device (e.g., because it was outside the range of radio module 32) is also taken into account. It may also be intended to transmit a time series in which several opening and/or closing operations of the container 10 are stored together with the respective time of the action.

The radio module 32 is preferably a Bluetooth and especially preferred a Bluetooth-LE module. In alternative designs, other energy-saving and short-range radio protocols can be used. In a design as a Bluetooth or Bluetooth-LE module, the radio module 34 can be coupled with a commercially available mobile device, e.g., a smartphone or a tablet computer, and thus the information about the opening status of container 10 can be transmitted to this mobile device.

The use of a short-range radio connection by the radio module 32 also serves to protect the user's privacy. If a longer-range connection is planned, it can be encrypted to prevent unauthorized access to information transmitted by the radio module 32.

The mobile device with which the radio module 32 communicates is preferably equipped with a software (“App”), which evaluates the opening status of container 10 and passes appropriate instructions for the correct use of container 10 to the user of the mobile device. For example, at regular intervals, e.g., in the morning and/or evening, the user can be reminded of the use of the cosmetic product in container 10. A warning signal can also be given if the container 10 is left unsealed unintentionally for a long period of time. This prevents the cosmetic product from drying out.

In a further application of the arrangement a coupling with a house control system, a so-called Smart Home System, can be provided. Depending on the state of the arrangement of container 10 and lid 20, household appliances such as lamps or a radio can be controlled.

If the user agrees, it may also be planned to pass on information on the use of the cosmetic product to a manufacturer of the cosmetic product or an intermediary service provider on the basis of the opening status of container 10. This service provider can use the information to compile statistics on the use of his products, which can contribute to the further development and/or improvement of the products. For reasons of data security and the protection of the user's privacy, the information is preferably passed on and evaluated anonymously to a manufacturer or service provider, whereby only (rough) location coordinates of the intermediate mobile device may be passed on in order to be able to evaluate the product data regionally.

It may also be planned to carry out an analysis of the estimated contents of container 10 on the basis of the number of opening or closing operations of the lid 20. This can be designed to be self-learning, in that feedback from the user on the actual contents of container 10 is used to adjust a stored value for the quantity of product removed during each opening operation.

It should be noted that the basic structure shown, in which the circuit arrangement 30 and thus the entire additional functionality described is located in the lid 20, is an advantageous embodiment, since the lid 20 shown, possibly with differently designed outer hoods 21, can be used for a number of products with differently designed and also differently sized containers 10.

In alternative embodiments, however, it is also conceivable to position the circuit arrangement 30 in container 10 and not in lid 20. A switch can, for example, be located in the area of thread 12 and operated by a screwed-on lid 20. It is also conceivable to position a magnetic switch in one of the two components—in container 10 or in lid 20—and a triggering magnet in the other part of the arrangement.

In the example shown, a button cell battery is used for the energy supply of circuit arrangement 30. By using the battery holder 33, this battery can be replaced, so that the circuit arrangement 30 can be used longer than the life of the battery. It is conceivable, for example, to make the lid 20 available separately from the container 10, so that the lid 20 with the circuit arrangement 30 can be used several times, whereas a container 10 with product content can be purchased or refilled. In alternative embodiments it is possible to use a rechargeable battery, whereby various methods for recharging the battery are conceivable. On the one hand, a charging socket could be formed on the lid or container, for example a micro-USB socket. Alternatively, inductive charging via charging stations for mobile devices, which are now commonplace, is also conceivable. Finally, a so-called energy harvesting can be used, whereby, for example, a piezo element is formed in the container or lid, which generates energy during each screwing process, which is used to recharge the rechargeable battery. A solar cell in the lid could also be used to recharge the rechargeable battery.

FIG. 6 shows an alternative embodiment of a lid 20, which can be used together with container 10, for example, according to the examples shown above. Identical reference marks indicate identical or similarly acting elements. With regard to its basic design, lid 20 of FIG. 6 corresponds to the design shown in the previous figures. Explicit reference is made to the corresponding description.

The example in FIG. 6 differs in the realization of the spring pre-tensioning of the sealing plate 24, where there is only one centrally arranged spring 25, which is guided on two cylindrical sockets, which are formed concentrically on the upper inner side of the insert 22 and the upper side of the sealing plate 24. Depending on the dimensions of the components of the circuit arrangement, in particular the radio module 32, the battery holder 33 or the inserted battery and the switch 34, the arrangement of several springs 25 (FIG. 1-5) or the arrangement with the central spring 25 according to FIG. 6 can be advantageous.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE SYMBOL LIST

10 Container
11 Cavity
12 Thread
13 Upper edge
14 Vessel
15 Grip edge
16 Outer shell
20 Lid
21 Outer hood
22 Deployment
23 Thread insert
231 Groove
24 Sealing plate
241 Outer edge
242 Support ring
25 Spring
30 Circuit arrangement
31 Circuit board
32 Radio module
33 Battery holder
34 Switch

1-15. (canceled)

16. An arrangement, comprising:
a container configured to receive a cosmetic product;
a lid configured to close the container; and
a circuit arranged on or in the container, or arranged on or in the lid, wherein the circuit includes a radio module, and the circuit is configured to detect an opening status of the arrangement and to output the detected opening status via the radio module.

17. The arrangement of claim 16, wherein the radio module is configured to output the detected opening status in a 2.4 GHz frequency band.

18. The arrangement of claim 16, wherein the radio module is configured to output the detected opening status according to a standardized protocol for short-range radio transmission.

19. The arrangement of claim 18, wherein the radio module is a Bluetooth, Bluetooth LE, or ZigBee module.

20. The arrangement of claim 16, wherein the circuit further comprises a switch configured to detect the opening status.

21. The arrangement of claim 20, further comprising:
a sealing plate arranged in the lid, wherein the sealing plate rests on an upper edge of the container when the container is closed.

22. The arrangement of claim 21, wherein the sealing plate is coupled to the switch.

23. The arrangement of claim 22, wherein the sealing plate is mounted so as to be axially displaceable and is biased in a direction of the container by at least one spring.

24. The arrangement of claim 16, wherein the container and the lid are joined by a screw connection.

25. The arrangement of claim 20, wherein the circuit, including the radio module, the switch and a power source for supplying power to the circuit arrangement are arranged in the lid.

26. An operating method for an arrangement comprising a container for receiving a cosmetic product and a lid for closing the container, the operating method comprising:
detecting an opening status of the arrangement, wherein the opening status indicates whether the container is closed by the lid; and
outputting, via a radio module of the arrangement, the detected opening status.

27. The operating method of claim 26, wherein the detected opening status is output by a radio protocol for short-range radio transmission.

28. The operating method of claim 26, wherein the detected opening status is repeatedly output at regular time intervals.

29. The operating method of claim 26, wherein the detected opening status is output only when the arrangement is open.

30. The operating method of claim 26, wherein the detected opening status is output when it is detected that the opening status has changed.
